(19) United States
(12) Patent Application Publication
(10) Pub. No.: US 2013/0146212 A1
(43) Pub. Date: Jun. 13, 2013

(54) Method for Joining a Layer of Material in Order to Produce a Raw Tire Blank

(71) Applicants: Jerome Frecon, Lussat (FR); Alain Charles, Orcines (FR); Fabrice Canadell, Mamoudzou (FR)

(72) Inventors: Jerome Frecon, Lussat (FR); Alain Charles, Orcines (FR); Fabrice Canadell, Mamoudzou (FR)

(73) Assignees: Michelin Recherche et Technique S.A., Granges-Paccot (CH); COMPAGNIE GENERAL DES ETABLISSEMENTS MICHELIN, Clermont-Ferrand (FR)

(21) Appl. No.: 13/520,135

(22) PCT Filed: Dec. 22, 2010
(86) PCT No.: PCT/FR2010/052881

§ 371 Date: Sep. 25, 2012

(30) Foreign Application Priority Data
Dec. 29, 2009 (FR) 0959638

(51) Int. Cl. B29D 30/08

(52) U.S. Cl. CPC B29D 30/08
USPC 156/123; 156/394.1

(57) ABSTRACT

A method for jointing an external layer (12) of material to a base layer (14) to produce a green tire, the green tire having an axis of revolution (X), the method comprising a step of applying the outer layer (12) to the base layer (14), followed by a step of jointing the outer layer (12) to the base layer (14). The jointing step is done using a pressing element (18) surrounding the outer layer (12) and elastically deformable between a configuration called the enlarged configuration and a configuration called the outer-layer (12) pressing configuration, in which the pressing element (18) applies a radial pressure to the outer layer, the jointing step comprising the following steps: the passage of the pressing element (18) from the enlarged configuration to the layer-pressing configuration, the movement of the pressing element (18) in the pressing configuration, in the axial direction (X) of the green tire.

The present invention relates to the field of tire manufacture. More specifically, the invention relates to the stitching or alternatively the jointing of an outer layer of material to a base layer.

The method of producing a tire comprises steps of assembling layers, during which steps a certain number of layers of reinforcing products and of rubbery profiled elements are stacked up by winding them onto a drum of cylindrical overall shape, the layers corresponding to different types of compound. The collection of layers is then followed by a shaping step, so as to obtain a green tire which will subsequently be vulcanized in order to form the tire.

While the various layers are being assembled it is important to make the layers adhere to one another by utilizing the natural stickiness of unvulcanized rubber while at the same time avoiding any inclusion of air between the layers, as such inclusion would lead to the formation of defects at the time of vulcanizing. To do this, the layers are stitched together, which means that the application of a new layer is followed by a step of jointing the layer to the previous layer.

In general, the stitching is performed using a roller operated by a pneumatic actuating cylinder, the roller coming into contact with the layer that has just been applied and applying mechanical pressure to this layer while this layer is driven in a rotational movement. During the rotation of the layer, the roller is also moved in the axial direction of the drum so that the pressure is applied to the entire surface area of the layer and air is expelled towards one of the axial ends of the layer of product.

It so happens that the stitching method takes a certain amount of time in the tire building method, particularly in the case of large tires, for example of the construction plant type. This is because after each new layer is applied, the drum has to be revolved several times in order to ensure that the roller has been able to cover the entire surface area of the layer.

It is a notable object of the present invention to reduce the time taken to build a tire.

To do that, a notable subject of the invention is a method for jointing an external layer of material, preferably rubber, to a base layer to produce a green tire, the green tire having an axis of revolution, the method comprising a step of applying the outer layer to the base layer, followed by a step of jointing the outer layer to the base layer, characterized in that the jointing step is done using a pressing element surrounding the outer layer and elastically deformable between a configuration called the enlarged configuration and a configuration called the outer-layer pressing configuration, in which the pressing element applies a radial pressure to the outer layer, the jointing step comprising the following steps:
the passage of the pressing element from the enlarged configuration to the layer-pressing configuration,
the movement of the pressing element in the pressing configuration, in the axial direction of the green tire.

Thus, it is proposed that use be made of an elastic pressing element arranged all around the outer layer so that it can apply a radial pressure all around the layer simultaneously. This means that the pressing element can cover the entire surface area of the outer layer very quickly, through a simple axial translational movement of the pressing element, without it necessarily being necessary to drive the outer layer in a rotational movement.

Also, whereas previously it was necessary for the drum to undergo several revolutions in order to ensure the jointing of the entirety of the surface area of the outer layer, a single translational movement may be sufficient thanks to the jointing method set out hereinabove, hence saving time. It will be appreciated that the greater the diameter of the tire, the greater will be the amount of time saved. It will be noted that the method also allows the operators to be kept more gainfully employed, because there is no need for them to wait around while the layers are being stitched, as this step has now become particularly swift.

It will be noted that the method proposed hereinabove can be carried out at various steps in the tire building method, notably when applying layers flat on the drum or alternatively when applying layers after the green tire has been shaped.

It will be noted that the “outer layer” is generally a layer of compound of a rubbery nature which may be a profiled element or a reinforcing ply. Moreover, the expression “base layer” means any support to which the outer layer may be applied. The base layer may for example denote a layer of compound, several juxtaposed or overlapping layers of compounds, or one or more reinforcing ply. A reinforcing ply means a ply made up of lengths of threads coated in rubber, running parallel to one another and making a given angle with the circumferential direction of the tire. The method described hereinabove may further comprise one or more of the following features, considered alone or in combination.

The pressing element delimits a closed outline of given perimeter, preferably substantially circular of given diameter, and is configured in such a way that the perimeter of its outline, when it is in the rest configuration, is less than the external perimeter of the base layer so that the pressing element in the pressing configuration applies a compression force compressing the outer layer radially against the base layer. Thus, when the pressing element is in the pressing configuration, it experiences a return force which tends to cause it to revert to its rest configuration, of smaller diameter, thus applying a centripetal pressure all around the outer layer. It will be noted that the rest configuration of the pressing element corresponds to the configuration in which the elastic-return energy of the pressing element is zero. The diameter of the pressing element in the rest configuration is smaller than the diameter in the pressing configuration (which diameter substantially corresponds to the outside diameter of the outer layer), which is itself smaller than the diameter in the enlarged configuration.

The method comprises a step in which the pressing element passes from the pressing configuration into the enlarged configuration under the action of deformation means, comprising pneumatic actuating cylinders that deform the pressing element. Thus, before the outer layer is jointed, the deformation means allow the pressing element to be stretched so that it can be positioned around the outer layer.

When the pressing element is in the pressing configuration, the deformation means are operated in such a way as to increase or decrease the pressure applied to the outer layer. The pressure applied by the pressing element can thus be adjusted, for example according to the diameter of the base layer. It will be noted that this embodiment in particular allows use to be made of one and the same pressing element for applying various types of layers, notably layers of different diameters. However, even without operating the deformation means in order to increase or decrease the pressure, one and the same pressing element can be used for applying different types of layers.

In order to improve the cycle time of the jointing step, use may advantageously be made of two pressing elements, each being moved in the axial direction in opposite directions from an equatorial plane of the green tire. Aside from the fact that the length of time spent on the jointing method is further shortened, this also ensures that the layers of the tire are jointed symmetrically, thus improving the qualities of the tire and making it possible to get over problems associated with the axial compression of the green tire.

Another subject of the invention is a method of manufacturing a green tire comprising a jointing method as described hereinabove.

Another subject of the invention is a device for jointing an outer layer of material to a base layer to produce a green tire, the green tire having an axis of revolution, characterized in that the device comprises:
a pressing element configured to surround the outer layer when it is applied to the base layer, delimiting a closed outline of a given perimeter, the pressing element being elastically deformable between a configuration called the enlarged configuration and a configuration called the outer-layer pressing configuration, in which the pressing element is configured to apply radial pressure to the outer layer,
movement means for moving the pressing element in the pressing configuration in the axial direction of the green tire.

This device allows use to be made of the jointing method according to the invention. The comments given hereinabove regarding the method also apply to the device.

The device may further comprise one or more of the following features, considered alone or in combination.

The device further comprises deformation means, for example comprising pneumatic actuating cylinders, for deforming the pressing element and designed to cause it to pass from its pressing configuration into the enlarged configuration.

The deformation means comprise pneumatic actuating cylinders distributed around the pressing element each activating an actuating cylinder rod of which one end is fixed to the pressing element so as to be able to enlarge the perimeter of the pressing element through elasticity. Thus, the actuating cylinders allow the pressing element to be enlarged by pulling at discrete locations along its entire outline.

The end of the rod of each actuating cylinder comprises a cavity to house the pressing element, having a retaining shape for retention of the pressing element, leaving the pressing element free to rotate within the cavity. Thus, when the pressing element is moved in the axial direction, it can roll over the outer layer, thus preventing any slippage which carries the risk of damaging the outer layer. According to one embodiment, the pressing element is mounted in the cavity by threading.

The pressing element is a helical spring of circular axis. it will be noted that the axis of the helical spring corresponds to the axis that passes through the centre of the turns and is also known as the neutral axis or axis of winding. According to one example, the spring is mounted such that it can rotate about its axis. Furthermore, again according to one example, the spring is butt-jointed in a sleeve.

The deformation means are carried by a support frame mounted such that it can move in the axial direction of a rotary drum under the action of the movement means.

The invention will be better understood from reading the description that will follow, given solely by way of example and made with reference to the drawings in which:

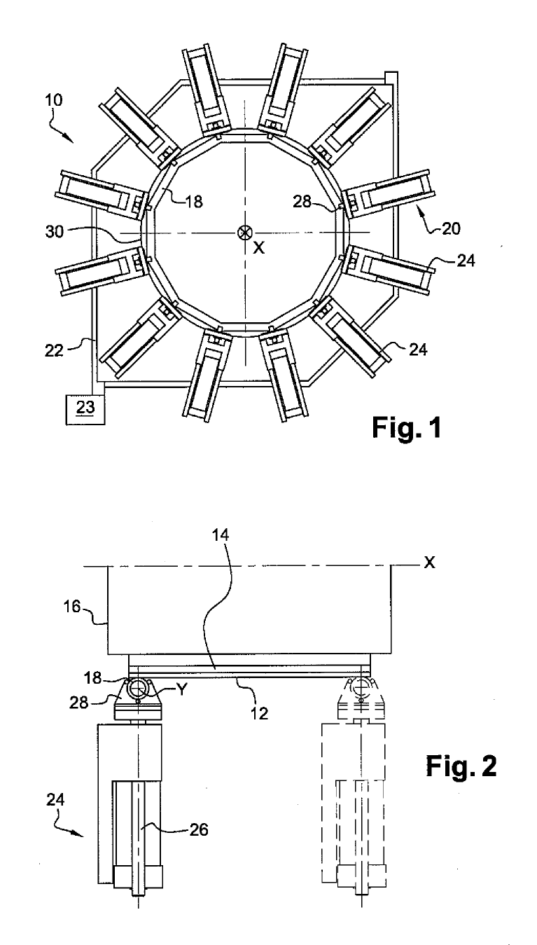

FIG. 1 is a schematic side view of a jointing device according to one embodiment, and

FIG. 2 is a schematic cross section of the device of FIG. 1, illustrating the jointing method.

FIG. 1 depicts part of a jointing device 10 for building a green tire. The device 10 is installed in a tire plant that builds tires for passenger vehicles or for industrial vehicles. The device 10 allows an outer layer 12 of material, in this instance a layer of compound, to be jointed (or pressed firmly) to a base layer 14, for example a lower layer of compound, a reinforcing layer, several superposed and/or juxtaposed layers of rubber and/or a support.

The layers 12, 14, together with other layers, are assembled with one another to create a green tire, having an axis of revolution X that coincides with the axis of revolution of a cylindrical drum 16 on which the layers are superposed.

The device 10 also comprises a pressing element 18, deformation means 20 for deforming the element 18, these means being borne by a support frame 22, and movement means 23 for moving the element 18.

The pressing element 18 is an elastically deformable element delimiting a closed outline that has a perimeter. More specifically, the pressing element 18 is of circular shape, at least when it is in the rest configuration, its axis of revolution coinciding with the axis X. In this example, the element 18 is a helical spring of circular axis Y, visible in FIG. 2. The spring 18 is butt-jointed using a sleeve, which means that two ends of a linear helical spring are joined together to form a circle.

The pressing element 18 is configured to surround the outer layer 12 when it is applied to the base layer 14. It is elastically deformable notably between three configurations, namely a rest configuration, an outer-layer 12 pressing configuration, in which the pressing element applies radial pressure to the outer layer 12, as illustrated in FIG. 2, and an enlarged configuration illustrated in FIG. 1.

The rest configuration corresponds to the configuration in which the return energy of the element 18 is zero. In this configuration, the perimeter of the outline of the element 18 is less than the perimeter in the pressing configuration, which is itself less than the perimeter in the enlarged configuration. In other words, the diameter of the element 18 is increased between the rest configuration and the pressing configuration, and then between the pressing configuration and the enlarged configuration. Moreover, the perimeter of the outline of the element 18 when in the rest configuration is less than the external perimeter of the base layer 14, so that the pressing element 18 in the pressing configuration applies a compressive force compressing the outer layer 12 against the base layer 14.

The means 20 are means of deforming the pressing element 18, which are designed to cause it to pass from its pressing configuration to the enlarged configuration. The means 20 comprise several pneumatic actuating cylinders 24, uniformly distributed around the pressing element 18, each activating an actuating cylinder rod 26 of which one end 28 is fixed to the pressing element 18, so as to be able to enlarge the perimeter of the pressing element through elasticity. More specifically, the end 28 of the rod 26 of each actuating cylinder 24 comprises a cavity 28 to house the pressing element 18, having a shape that retains the pressing element while leaving the pressing element free to turn in the cavity 28. In other words, when the element 18 is in the cavity 28, it can rotate on itself, about its axis Y. In this example, the cavity 28 has a C-shaped cross section, the element 18 being mounted in the cavity 28 by threading. Still in this example, the means 20 comprise twelve actuating cylinders 24.

The support frame 22 carries the set of actuating cylinders 24. More specifically, the frame 22 delimits a circular opening 30, intended to be fitted around the drum 16, and on which the actuating cylinders 24 are mounted. The support frame 22 is also mounted such that it can be moved in the axial direction X of the rotary drum 16 under the action of the movement means 23.

The movement means 23 allow the pressing element 18 in the pressing configuration to be moved in the X direction so as to travel the entire axial length of the drum 16. For preference, the movement means 23 and the deformation means 20 are operated automatically.

The method of jointing using the device 10 will now be described. This method is implemented during a method of building a green tire, which method is itself implemented during a tire building method.

The jointing method first of all comprises a step of applying the outer layer 12 to the base layer 14, followed by a step of jointing the outer layer 12 to the base layer 14. To implement this jointing step, the pressing element 18 is fitted around the outer layer 12. For example, it is fitted as follows. The element 18 is initially positioned on the side of the drum 16, around the drum and beside the layers 14, 12 because it has previously been used for jointing a lower layer such as the layer 14. It then passes into the enlarged configuration under the action of the deformation means 20, so that it can be moved around the outer layer 12, by movement in the axial direction X.

The layer 12 is then jointed by first of all causing the pressing element to pass with the enlarged configuration to the pressing configuration. Thus, the element 18 applies radial pressure all around the layer 12.

Next comes a step of moving the pressing element 18 in the pressing configuration in the axial direction X using the means 23 so as to expel the air present between the layers, as illustrated in dotted lines in FIG. 2. Once the element 18 has been moved over the entire axial length of the drum 16, the layer 12 is correctly applied to the layer 14, air trapped between the two layers has been expelled via the axial ends of the layers and the two layers have been jointed satisfactorily.

The pressing element 18 can then be left to the side around the drum 16, beside the layers 14, 12 so that it clears the layer 12 and leaves space for the possible application of another layer. This new layer can then be jointed using the element 18, which can be brought in around the new layer by action of the deformation means 20.

It will be appreciated that the pressing element 18 allows a reduction in the time needed for jointing the layers to one another and thus allows a reduction in the cycle time for the building of a tire. This is because only a movement in the axial direction of the drum X is required and it is therefore not compulsory for the drum 16 to be rotated through several revolutions in order to achieve this jointing.

It will also be appreciated that one and the same pressing element 18 can be used for jointing various layers in the manufacturing method, without necessarily needing to modify it or needing to modify the operating parameters, this being something which is particularly economical.

Finally it will be noted that the invention is not restricted to the embodiment described hereinabove. In particular, when the pressing element 18 is in the pressing configuration, the deformation means 20 can be operated in such a way as to increase or decrease the pressure applied to the outer layer 12. For example, means may be provided for controlling the stroke of the actuating cylinder rods 26 according to the number of layers already superposed on the drum 16.

Moreover, use may be made of two pressing elements 18, each one moving in the axial direction X in opposite directions out from the equatorial plane of the green tire.

1. A method for jointing an external layer of material to a base layer to produce a green tire, the green tire having an axis of revolution, the method comprising a step of applying the outer layer to the base layer, followed by a step of jointing the outer layer to the base layer, wherein the jointing step is done using a pressing element surrounding the outer layer and elastically deformable between a configuration called the enlarged configuration and a configuration called the outer-layer pressing configuration, in which the pressing element applies a radial pressure to the outer layer, the jointing step comprising the following steps:
the passage of the pressing element from the enlarged configuration to the layer-pressing configuration; and
the movement of the pressing element in the pressing configuration, in the axial direction of the green tire.

2. The method according to claim 1, wherein, the pressing element delimits a closed outline of a given perimeter and is configured in such a way that the perimeter of its outline, when it is in the rest configuration, is less than the external perimeter of the base layer so that the pressing element in the pressing configuration applies a radial compression force compressing the outer layer radially against the base layer.

3. The method according to claim 1, comprising a step in which the pressing element passes from the pressing configuration into the enlarged configuration under the action of deformation means, comprising pneumatic actuating cylinders that deform the pressing element.

4. The method according to claim 3, during which when the pressing element is in the pressing configuration, the deformation means are operated in such a way as to increase or decrease the pressure applied to the outer layer.

5. The method according to claim 1, during which use is made of two pressing elements, each being moved in the axial direction in opposite directions from an equatorial plane of the green tire.

6. A method of manufacturing a tire comprising a jointing method according to claim 1.

7. A device for jointing an outer layer of material to a base layer to produce a green tire, the green tire having an axis of revolution, wherein the device comprises:
a pressing element configured to surround the outer layer when it is applied to the base layer, delimiting a closed outline of a given perimeter, the pressing element being elastically deformable between a configuration called the enlarged configuration and a configuration called the outer-layer pressing configuration, in which the pressing element is configured to apply pressure to the outer layer; and
movement means for moving the pressing element in the pressing configuration in the axial direction of the green tire.

8. The device according to claim 7, further comprising deformation means, for example comprising pneumatic actuating cylinders, for deforming the pressing element and designed to cause it to pass from its pressing configuration into the enlarged configuration.

9. The device according to claim 8, wherein the deformation means comprise pneumatic actuating cylinders distributed around the pressing element each activating an actuating cylinder rod of which one end is fixed to the pressing element so as to be able to enlarge the perimeter of the pressing element through elasticity.

10. The device according to claim 9, wherein the end of the rod of each actuating cylinder comprises a cavity to house the pressing element, having a retaining shape for retention of the pressing element, leaving the pressing element free to rotate within the cavity.

11. The device according to claim 7, wherein the pressing element is a helical spring of circular axis.

12. The device according to claim 8, wherein the deformation means are carried by a support frame mounted such that it can move in the axial direction of a rotary drum under the action of the movement means.
